(19) United States
(12) Patent Application Publication
(10) Pub. No.: US 2016/0242464 A1
(43) Pub. Date: Aug. 25, 2016

(54) ELECTRONIC CIGARETTE AND BATTERY ROD THEREOF

(71) Applicant: KIMREE HI-TECH INC., Tortola (VG)

(72) Inventor: Qiuming LIU, Huizhou, Guangdong (CN)

(21) Appl. No.: 14/650,487

(22) PCT Filed: Dec. 5, 2013
(86) PCT No.: PCT/CN2013/088583

§ 371 Date: Jun. 8, 2015

(30) Foreign Application Priority Data
Nov. 18, 2013 (CN) 201320729011.4

(51) Int. Cl. A24F 47/00; H01M 2/10

(52) U.S. Cl. CPC A24F 47/002; H01M 2/1022

(57) ABSTRACT

A battery rod and an electronic cigarette having the battery rod are provided. A connector is provided in the inside of one end of a battery cartridge of the battery rod. The battery cartridge includes an inner protective cartridge and an outer protective cartridge which are coaxially arranged. Both the inner protective cartridge and the outer protective cartridge are parts made of a non-metallic material. A fastening ring for clamping the connector is sleeved on the outside of one end of the inner protective cartridge at a position corresponding to a position of the connector. The outer protective cartridge and fastening ring are coaxially arranged, and the outer protective cartridge and fastening ring are staggered in an axial direction of the battery cartridge. One end surface of the outer protective cartridge faces one end surface of the fastening ring.

The present application claims the priority to Chinese patent application No. 201320729011.4, titled “ELECTRONIC CIGARETTE AND BATTERY ROD THEREOF” and filed with the State Intellectual Property Office of the People's Republic of China on Nov. 18, 2013, which is incorporated herein by reference in its entirety.

### FIELD

The present application relates to the technical field of electronic cigarette fittings, and in particular, to a battery rod. The present application also relates to an electronic cigarette having the battery rod.

### BACKGROUND

The electronic cigarette is a common electronic product simulating the cigarette. The battery rod, as a main structure component, plays an important role in a whole working effect of the electronic cigarette. With improved production and increasing usage requirements, higher requirements are set by people for the performance of the battery rod.

In a conventional electronic cigarette, a protective cartridge is provided outside main components of the battery rod, to protect the main components of the battery rod from being affected by external environment. Normally, the protective cartridge for the battery rod is made of a hard material such as copper, iron or steel; although basic requirements in structure assembling and usage of the electronic cigarette may be satisfied, the soft touch of a real cigarette may not be simulated with the hard material; and user experience is greatly affected due to a large weight of the protective cartridge.

Furthermore, a connector, which is inserted at one end of the protective cartridge for the battery rod and is connected to an atomizer, is apt to fall off during a detachment from the atomizer.

Hence, currently, how to improve the hand feeling and usage feeling of the electronic cigarette and how to avoid the problem that the connector is apt to fall off are great technical problems to be solved by those skilled in the art.

### SUMMARY

The application intends to provide a battery rod with which a hand feeling and a usage feeling of an electronic cigarette may be improved. The application further intends to provide an electronic cigarette having the above battery rod.

In order to solve the technical problems described above, a battery rod is provided in the present application. The battery rod is for assembling with an atomizer to form an electronic cigarette. The battery rod includes a battery cartridge, and a connector which is provided at the inside of one end of the battery cartridge and is for connecting to the atomizer. The battery cartridge includes an inner protective cartridge and an outer protective cartridge which are coaxially arranged, the inner protective cartridge being arranged inside and the outer protective cartridge being arranged outside, and both the inner protective cartridge and the outer protective cartridge are parts made of a non-metallic material. A fastening ring for clamping the connector is sleeved on the outside of one end of the inner protective cartridge at a position corresponding to a position of the connector. The outer protective cartridge and fastening ring are coaxially arranged, the outer protective cartridge and fastening ring are staggered in an axial direction of the battery cartridge, and one end surface of the outer protective cartridge faces one end surface of the fastening ring.

Preferably, an outer circumferencial surface of the outer protective cartridge and an outer circumferencial surface of the fastening ring are flush with each other.

Preferably, a coating layer is provided on the outer circumferencial surface of the outer protective cartridge and the outer circumferencial surface of the fastening ring.

Preferably, the coating layer is a paster.

Preferably, both the inner protective cartridge and the outer protective cartridge are parts made of a non-metallic material having a hardness smaller than that of copper.

Preferably, the battery cartridge is any one of a plastic part, a rubber part and a paper part.

Preferably, the fastening ring is a part made of a metallic material.

Preferably, the fastening ring is made of one of copper, iron and steel.

An electronic cigarette is further provided in the application. The electronic cigarette includes a battery rod and an atomizer which are connected to each other. The battery rod is any one of the battery rods describe above.

Preferably, an assembling end of the atomizer is provided with a buckle, and an assembling end of the battery rod is provided with a locating slot fitting with the buckle and a spring leaf

Compared with conventional technologies, structures of the battery rod and the electronic cigarette including the battery rod and the atomizer provided in the application are steady and reliable, and the connector is avoided from falling off; the battery cartridge made of the non-metallic material touches soft and comfortable and has a light weight, and the hand feeling of the cigarette may be well simulated, thereby greatly improving the whole simulation degree of the electronic cigarette and significantly optimizing the user experience. Furthermore, the outer protective cartridge and the fastening ring are coaxially provided and are located at different positions in the axial direction of the battery cartridge, and one end surface of the outer protective cartridge faces one end surface of the fastening ring; hence, a corresponding coating structure coated on the outer protective cartridge and the fastening ring may be avoided from being damaged by the external force, thereby lengthening the service life of the electronic cigarette.

According to another preferred embodiment of the application, the outer circumferencial surface of the outer protective cartridge and the outer circumferencial surface of the fastening ring are flush with each other. With the structure that the outer circumferencial surface of the outer protective cartridge and the outer circumferencial surface of the fastening ring are flush with each other, an outer structure of the electronic cigarette may be further optimized, the battery rod is avoided from an uneven outer surface, and accordingly, the user experience is further improved. In addition, the corresponding structure coated on the outer protective cartridge and the fastening ring may be avoided from being damaged by the external force, and a user is avoided from being hurt by the fastening ring during usage. Besides, with the above structure, outer surfaces of electronic cigarettes placed together may be closely abutted against each other; hence, scratchings between the electronic cigarettes, falling of electronic parts and oil leaking of the atomizer, which are caused by vibration when the electronic cigarettes are transported or are put in a pocket of a user, are avoided.

### BRIEF DESCRIPTION OF THE DRAWINGS

For more clearly illustrating technical solutions according to embodiments of the present application or conventional technologies, drawings to be used in descriptions of the embodiments or the conventional technologies are briefly introduced hereinafter. Apparently, the drawings are merely used to illustrate some embodiments of the present application, and those of ordinary skill in the art may achieve other drawings based on these drawings without any creative efforts.

FIG. 1 is a section view of an assembling structure of a battery rod according to an embodiment of the application;

FIG. 2 is an enlarged schematic view of section A in FIG. 1;

FIG. 3 is a structure schematic view of a first structure of an electronic cigarette according to an embodiment of the application, where an atomizer and a battery rod are not connected; and

FIG. 4 is a structure schematic view of a second structure of an electronic cigarette according to an embodiment of the application, where an atomizer and a battery rod are not connected.

### DETAILED DESCRIPTION OF THE EMBODIMENTS

A battery rod is provided in the application, and a hand feeling and a usage feeling of an electronic cigarette may be improved with the battery rob. In addition, an electronic cigarette having the battery rod is provided.

The application is further described in detail in conjunction with drawings and embodiments, for making a solution of the application better understood by those skilled in the art.

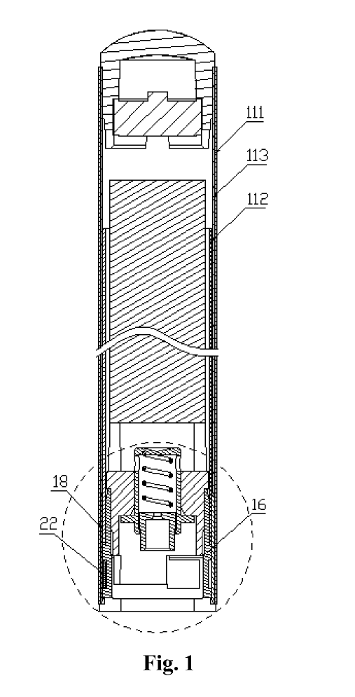

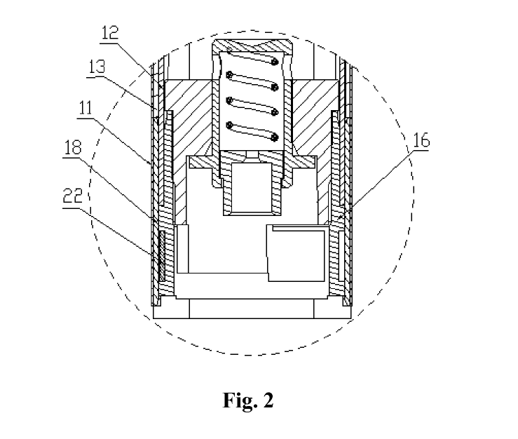

Reference may be made to FIG. 1 and FIG. 2. FIG. 1 is a section view of an assembling structure of a battery rod according to an embodiment of the application; and FIG. 2 is an enlarged schematic view of section A in FIG. 1.

In the embodiment, the battery rod provided in the present application may be assembled with an atomizer to form an electronic cigarette. The battery rod includes a battery cartridge, and a connector 16 provided at the inside of one end of the battery cartridge and connected to the atomizer. The battery cartridge includes an inner protective cartridge 112 and an outer protective cartridge 113 which are coaxially arranged, where the inner protective cartridge 112 is arranged inside and the outer protective cartridge 113 is arranged outside. Both the inner protective cartridge 112 and the outer protective cartridge 113 are parts made of a non-metallic material. At a position corresponding to the position of the connector 16, a fastening ring 18 for clamping the connector 16 is sleeved on the outside of one end of the inner protective cartridge 112. The outer protective cartridge 113 and fastening ring 18 are coaxially arranged, and the outer protective cartridge 113 and fastening ring 18 are staggered in an axial direction of the battery cartridge. One end surface of the outer protective cartridge 113 faces one end surface of the fastening ring 18.

With an arrangement of the above structure of the application, the connector 16 is avoided from falling off, and the battery cartridge made of the non-metallic material touches soft and comfortable, and a hand feeling of a cigarette may be well simulated, thereby greatly improving an overall simulation degree of the electronic cigarette and significantly optimizing the user experience. Furthermore, the outer protective cartridge 113 and the fastening ring 18 are coaxially provided and are located at different positions in the axial direction of the battery cartridge, and one end surface of the outer protective cartridge 113 faces one end surface of the fastening ring 18; hence, a corresponding coating structure coated on the outer protective cartridge 113 and the fastening ring 18 may be avoided from being damaged due to an external force, thereby lengthening the service life of the electronic cigarette.

Further, an outer circumferencial surface of the outer protective cartridge 113 and an outer circumferencial surface of the fastening ring 18 are flush with each other. With the structure that the outer circumferencial surface of the outer protective cartridge 113 and the outer circumferencial surface of the fastening ring 18 are flush with each other, an outer structure of the electronic cigarette may be further optimized, the battery rod is avoided from an uneven outer surface, and accordingly, the user experience is further improved. In addition, the corresponding structure coated on the outer protective cartridge 113 and the fastening ring 18 may be avoided from being damaged by the external force, and a user is avoided from being hurt by the fastening ring during usage. Besides, with the above structure, outer surfaces of electronic cigarettes placed together may be closely abutted against each other; hence, scratchings between the electronic cigarettes, falling of electronic parts and oil leaking of the atomizer, which are caused by vibration when the electronic cigarettes are transported or are put in a pocket of a user, are avoided.

Specifically, a coating layer 111 is provided on the outer circumferencial surface of the outer protective cartridge 113 and the outer circumferencial surface of the fastening ring 18. The coating layer 111 may further ensure a flatness of an outer circumferencial surface of an assembling structure between the battery cartridge 11 and the connector 16, thereby further optimizing an overall outer structure of the electronic cigarette.

More specifically, the coating layer 111 is a paster. With a low procurement cost, a huge quantity of market supply, and an excellent bonding and fixation effect, the paster may meet assembling requirements of the electronic cigarette and the production cost of the electronic cigarette is effectively reduced. With the coated paster, the electronic cigarette having the battery rod further looks like the cigarette, thus improving the user experience.

On another hand, both the inner protective cartridge 112 and the outer protective cartridge 113 are parts made of a non-metallic material having a hardness smaller than that of copper. With the parts made of a soft material having a small hardness, the whole hand feeling of the electronic cigarette may be further optimized, and the user experience is better.

Furthermore, the battery cartridge 11 may be any one of a plastic part, a rubber part and a paper part. Of course, the battery cartridge 11 is not restricted to the plastic part, the rubber part and the paper part as long as practical usage requirements of the electronic cigarette may be satisfied.

Further, the fastening ring 18 is a part made of a metallic material such as copper, iron, steel or the like, and the structure strength and tenacity of the metallic material are better than those of a non-metallic material; hence, it is ensured that the fastening ring 18 may not be torn easily during assembling. Therefore, with a cooperation of the fastening ring 18 made of the metallic material and the battery cartridge 11 made of the non-metallic material, advantages such as a steady and reliable battery rod structure, a high product yield, a small overall weight and a high similarity to the cigarette may be realized.

An electronic cigarette according to an embodiment of the application includes a battery rod and an atomizer which are connected to each other. The battery rod is the battery rod according to the embodiment described hereinabove. The hand feeling and the user experience of the electronic cigarette are good.

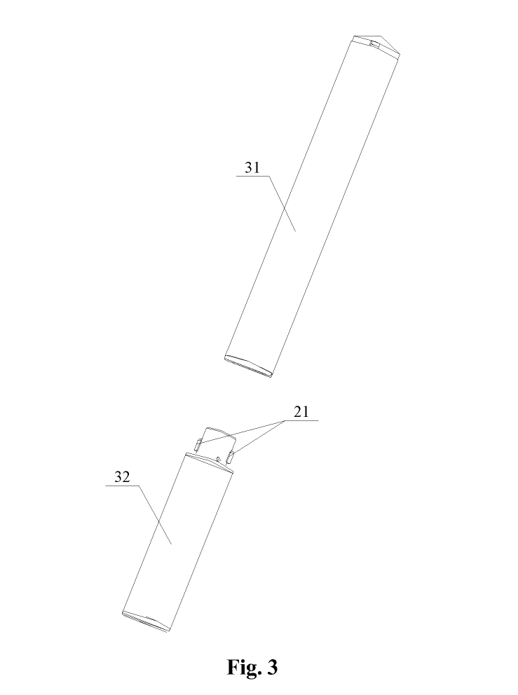

Reference may be made to FIGS. 1 to 3. FIG. 3 is a structure schematic view of a first structure of an electronic cigarette according to an embodiment of the application, where an atomizer and a battery rod are not connected.

An assembling end of the atomizer 32 is provided with a buckle 21, and an assembling end of the battery rod 31 is provided with a locating slot (not shown in the figure) fitting with the buckle 21 and a spring leaf 22 extending into the locating slot. During a usage, the assembling end of the atomizer 32 is inserted into the assembling end of the battery rod 31, to retain the buckle 21 in the locating slot, and the spring leaf 22 gets the buckle 21 clamped to the locating slot and fixed; hence, an assembling structure of the battery rod 31 and the atomizer 32 is more steady and reliable.

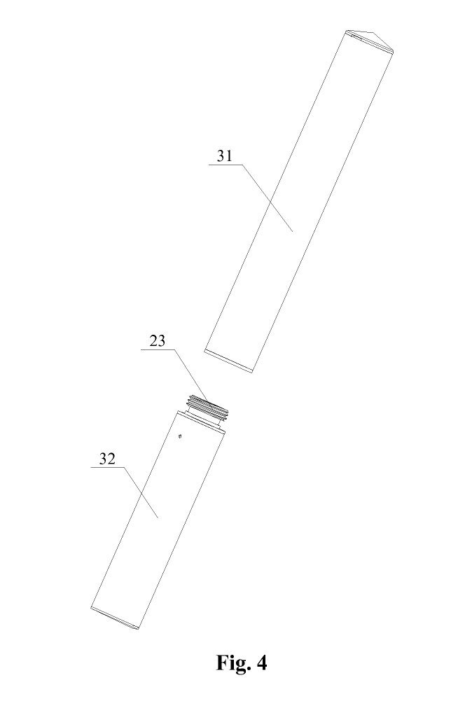

Reference may be made to FIG. 4. FIG. 4 is a structure schematic view of a second structure of an electronic cigarette according to an embodiment of the application, where an atomizer and a battery rod are not connected.

An assembling end of the atomizer 32 is provided with an external thread part 23 and an assembling end of the battery rod 31 is provided with an internal thread part (not shown in the figure) fitting with the external thread part 23. The assembling structure of fitted threads is simple and reliable, and a process of assembling is easy.

Furthermore, the atomizer and the battery rod may be attached to each other through a magnet device, to realize a connection of the atomizer and the battery rod. Obviously, assembling forms of the atomizer and the battery rod are not restricted to clamping fit, thread fit and magnetic attachment described above as long as practical usage requirements of the electronic cigarette are satisfied.

In view of above, with the battery rod and the electronic cigarette including the battery rod and the atomizer provided in the application, the connector is avoided from falling off, the battery cartridge made of the non-metallic material touches soft and comfortable, and the hand feeling of the cigarette may be well simulated, thereby greatly improving the whole simulation degree of the electronic cigarette and significantly optimizing the user experience. Furthermore, the outer protective cartridge and the fastening ring are coaxially provided and are located at different positions in the axial direction of the battery cartridge, and one end surface of the outer protective cartridge faces one end surface of the fastening ring; hence, the corresponding coating structure coated on the outer protective cartridge and the fastening ring may be avoided from being damaged by the external force, thereby lengthening the service life of the electronic cigarette.

Furthermore, the electronic cigarette having the battery rod is provided in the application, and the hand feeling and user experience of the electronic cigarette are good.

The battery rod and the electronic cigarette having the battery rod provided in the application are described in detail hereinabove. The principle and the embodiments of the present application are illustrated herein by specific examples. The above descriptions of embodiments are only intended to help the understanding of the method and the spirit of the present application. It should be noted that, many modifications and improvements may be made to the present application by those skilled in the art without departing from the principle of the present application, and these improvements and modifications are also deemed to fall into the protection scope of the present application defined by the claims.

1. A battery rod, which is configured to assemble with an atomizer to form an electronic cigarette, comprising: a battery cartridge, and a connector which is provided at the inside of one end of the battery cartridge and is configured to connect to the atomizer;
wherein the battery cartridge comprises an inner protective cartridge and an outer protective cartridge which are coaxially arranged, the inner protective cartridge being arranged inside and the outer protective cartridge being arranged outside, and both the inner protective cartridge and the outer protective cartridge are parts made of a non-metallic material;
a fastening ring for clamping the connector is sleeved on the outside of one end of the inner protective cartridge at a position corresponding to a position of the connector; and
the outer protective cartridge and fastening ring are coaxially arranged, the outer protective cartridge and the fastening ring are staggered in an axial direction of the battery cartridge, and one end surface of the outer protective cartridge faces one end surface of the fastening ring.

2. The battery rod according to claim 1, wherein an outer circumferencial surface of the outer protective cartridge and an outer circumferencial surface of the fastening ring are flush with each other.

3. The battery rod according to claim 1, wherein a coating layer is provided on an outer circumferencial surface of the outer protective cartridge and an outer circumferencial surface of the fastening ring.

4. The battery rod according to claim 3, wherein the coating layer is a paster.

5. The battery rod according to claim 1, wherein both the inner protective cartridge and the outer protective cartridge are parts made of a non-metallic material having a hardness smaller than a hardness of copper.

6. The battery rod according to claim 1, wherein the battery cartridge is any one of a plastic part, a rubber part and a paper part.

7. The battery rod according to claim 1, wherein the fastening ring is a part made of a metallic material.

8. The battery rod according to claim 7, wherein the fastening ring is made of one of copper, iron and steel.

9. An electronic cigarette, comprising a battery rod and an atomizer connected to each other, wherein the battery rod
comprises a battery cartridge, and a connector which is provided at the inside of one end of the battery cartridge and is configured to connect to the atomizer;
wherein the battery cartridge comprises an inner protective cartridge and an outer protective cartridge which are coaxially arranged, the inner protective cartridge being arranged inside and the outer protective cartridge being arranged outside, and both the inner protective cartridge and the outer protective cartridge are parts made of a non-metallic material;
a fastening ring for clamping the connector is sleeved on the outside of one end of the inner protective cartridge at a position corresponding to a position of the connector; and
the outer protective cartridge and fastening ring are coaxially arranged, the outer protective cartridge and the fastening ring are staggered in an axial direction of the battery cartridge, and one end surface of the outer protective cartridge faces one end surface of the fastening ring.

10. The electronic cigarette according to claim 9, wherein an assembling end of the atomizer is provided with a buckle, and an assembling end of the battery rod is provided with a locating slot fitting with the buckle and a spring leaf.

11. The electronic cigarette according to claim 9, wherein an outer circumferential surface of the outer protective cartridge and an outer circumferential surface of the fastening ring are flush with each other.

12. The electronic cigarette according to claim 9, wherein a coating layer is provided on an outer circumferential surface of the outer protective cartridge and an outer circumferential surface of the fastening ring.

13. The electronic cigarette according to claim 12, wherein the coating layer is a paster.

14. The electronic cigarette according to claim 9, wherein both the inner protective cartridge and the outer protective cartridge are parts made of a non-metallic material having a hardness smaller than a hardness of copper.

15. The electronic cigarette according to claim 9, wherein the battery cartridge is any one of a plastic part, a rubber part and a paper part.

16. The electronic cigarette according to claim 9, wherein the fastening ring is a part made of a metallic material.

17. The electronic cigarette according to claim 16, wherein the fastening ring is made of one of copper, iron and steel.
